(19) United States
(12) Patent Application Publication
(10) Pub. No.: US 2003/0161215 A1
(43) Pub. Date: Aug. 28, 2003

(54) Device and Method for Mixing Components

(75) Inventors: Franz-Joseph Hinken, Osnabruck (DE); Frank Lutzer, Hasbergen (DE)

Correspondence Address: GUDRUN E. HUCKETT, LONSSTR. 53, WUPPERTAL, 42289, DE

(73) Assignee: HILUTEC Systemtechnik GmbH & Co. KG, Hopsten-Halverde (DE)

(21) Appl. No.: 10/248,837

(22) Filed: Feb. 24, 2003

Related U.S. Application Data
(63) Continuation of application No. PCT/EP01/09719, filed on Aug. 22, 2001.

(30) Foreign Application Priority Data
Aug. 24, 2000 (DE) 100 41 552.0
Apr. 7, 2001 (DE) 201 06 164.3

(51) Int. Cl. B01F 7/02

(52) U.S. Cl. 366/300; 366/321; 366/327.3

(57) ABSTRACT

A mixing device has outer walls defining a mixing chamber that has an inlet opening for introducing the material to be mixed into the mixing chamber and an outlet opening spaced from the inlet opening for removing the material to be mixed after mixing from the mixing chamber. At least two mixing and conveying tools are arranged in the mixing chamber and act on the material to be mixed between the inlet opening and the outlet opening. The mixing and conveying tools are formed such that the material to be mixed is conveyed in the mixing chamber by each one of the mixing and conveying tools with at least one first section of the tools, respectively, in a first direction toward the outlet opening and with at least one second section of the tool, respectively, in a second direction opposite to the first direction.

### CROSS REFERENCE TO RELATED APPLICATIONS

This application is a continuation of international application PCT/EP01/09719 with an international filing date of Aug. 22, 2001, not published in English under PCT Article 21(2), and now abandoned.

### BACKGROUND OF INVENTION

1. Field of the Invention

The invention relates to a device and method for mixing at least two components. The device comprises a mixing chamber delimited by outer walls in which at least two mixing and conveying tools are acting on the material to be mixed between an inlet opening for the material to be mixed and an outlet opening spaced from the inlet opening. The method concerns mixing components in a mixing chamber provided with an inlet area for the material to be mixed and an outlet area spaced from the inlet area.

2. Description of the Related Art

Devices of the aforementioned kind are used, for example, in the food industry and pharmaceutical industry but also for sewage sludge or other components in other technical fields that are difficult to mix. Often so-called double shaft trough mixers are used in which two parallel shafts effect conveying and, at the same time, mixing of the materials introduced into the trough. As a result of the opposite rotation of the two shafts, the components to be mixed are circulated within the mixing chamber.

Typically, the material to be mixed will carry out approximately 10 to 15 circulations before exiting the mixing chamber through the outlet opening. The number of passes or circulation varies significantly depending on the components to be mixed.

In order to reduce the residence time of the material to be mixed within the mixer and to improve in this way the efficiency of the mixer, it has been suggested to insert partitions into the mixing chambers so that individual smaller mixing chambers are formed and the material to be mixed is transferred into the next mixing chamber only after having been mixed to a certain degree. In the case of sensitive material to be mixed, however, the impact of the components to be mixed on the partitions entails the risk of chipping or of causing other defects on the materials to be mixed (for example, in the case of tablets). Moreover, the advantageously closable openings of the partitions are subject to soiling and are difficult to clean, in particular, when a high level of hygienic requirements must be met, for example, in the case of the food industry or pharmaceutical industry.

### SUMMARY OF INVENTION

It is an object of the present invention to enable an effective mixing of components while avoiding the aforementioned disadvantages.

In accordance with the present invention, this is achieved in that the mixing and conveying tools are formed such that the material to be mixed contained in the mixing chamber can be conveyed by each mixing and conveying tool partially (with sections of the tool) in the direction of the outlet opening and partially (with sections of the tool) in opposite direction.

In regard to the method, this is achieved in that the material to be mixed entering the mixing chamber through the inlet opening is engaged by a first section of the mixing and conveying tools and transported in the direction of the outlet opening, wherein at the end of this section the material to be mixed impacts on a section of the mixing and conveying tools conveying in the opposite direction and is subjected to a transverse conveying action.

The capability of each mixing and conveying tool to convey over sections thereof the material to the outlet opening and with sections thereof to the inlet opening ensures an intensive mixing of the material to be mixed even in a mixing chamber which is not separated by interior walls (partitions). Therefore, a continuous mixing chamber can be used in which, however, still several flows of material to be mixed are effected by means of the varying conveying directions of the at least two mixing and conveying tools. In this way, openings closed by slides or similar devices that are prone to soiling are not needed. Moreover, partitions in general are not needed so that damage of the material to be mixed, for example, tablets, upon impact on partitions is avoided.

It is particularly advantageous to arrange the sections of each mixing and conveying tool conveying in the inlet direction and the outlet direction, respectively, alternatingly and sequentially so that uniform flows of the material to be mixed result.

A particularly beneficial configuration of several circulation paths results when in the boundary area between the sections of the mixing and conveying tool conveying in the outlet direction and the inlet direction, respectively, a transverse conveying action of the material to be mixed is provided for the purpose of supplying it to the additional mixing and conveying tool; the material to be mixed received thereat is conveyed partially in the opposite direction to the first mixing tool, respectively.

For example, material to be mixed conveyed by the first section in the direction of the outlet opening, upon reaching the second section in which mixing and conveying members conveying in the opposite direction are effective, is then conveyed transversely in the direction to the second mixing and conveying tool which then divides the received material to be mixed into a return flow for generating a first circulation path and into a second forwardly oriented flow for generating a second circulation path in the opposite direction.

The method according to the invention can be realized by two horizontal, adjacently arranged shaft members provided with mixing and conveying members having oppositely oriented pitch. Principally, bodies of rotation rotating about vertical axes are also suitable for forming suitable mixing and conveying tools.

A simultaneous drying of the material introduced into the mixing chamber for increasing the solid matter contents can be achieved when the device has correlated therewith a heating device. In particular, such a device can have heating channels in which, for example, an oil or another heating liquid circulates and which are matched to the walls which delimit the bottom side of the mixing chamber. This provides a very large heating surface so that an effective heat loading of the mixing chamber is achieved and the residence time of the material to be mixed in the mixing chamber can therefore be minimized.

A particularly advantageous embodiment results when several parallel shafts are arranged adjacent to one another and, in this way, the mixing chamber comprises several adjacently positioned areas in which the material is mixed. The areas can be separated from one another or connected with one another.

### BRIEF DESCRIPTION OF DRAWINGS

FIG. 1 is a plan view onto the mixing device according to the invention.

FIG. 2 is a side view of the device according to FIG. 1.

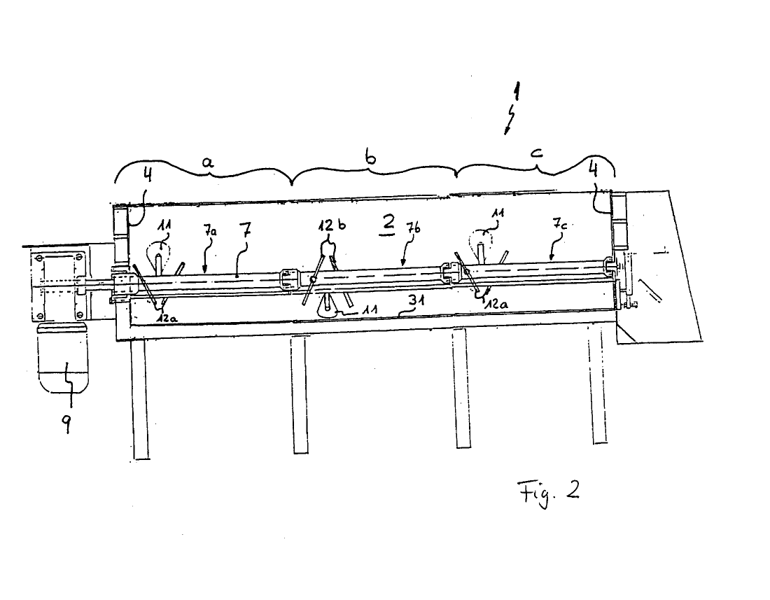

FIG. 3 is a section along the line III-III of FIG. 1.

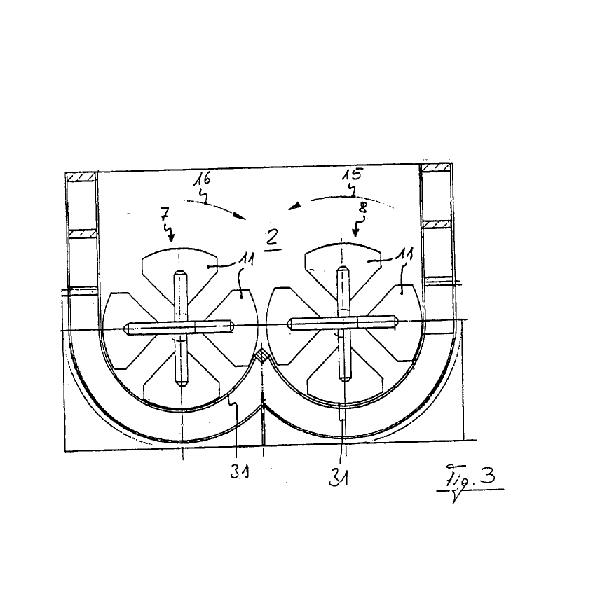

FIG. 4 is an alternative configuration of the mixing and conveying members in a view similar to that of FIG. 1.

FIG. 5 is a schematic view of different conveying sections of the mixing and conveying tools according to FIG. 1.

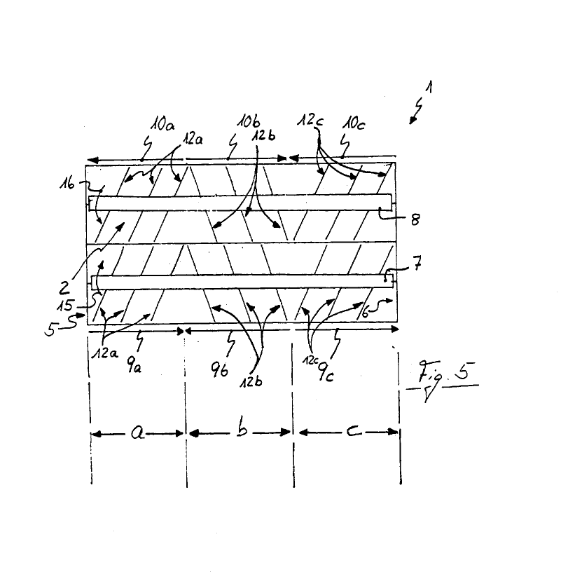

FIG. 6 is a schematic plan view onto the material flows in the mixing device.

FIG. 7 is a view similar to FIG. 1 onto the device provided with several mixing spaces.

FIG. 8 is a section along the line VIII-VIII of FIG. 7 showing heating channels for passing therethrough a heating medium and showing a cover at the top for providing a pressure-tight mixing chamber.

### DETAILED DESCRIPTION

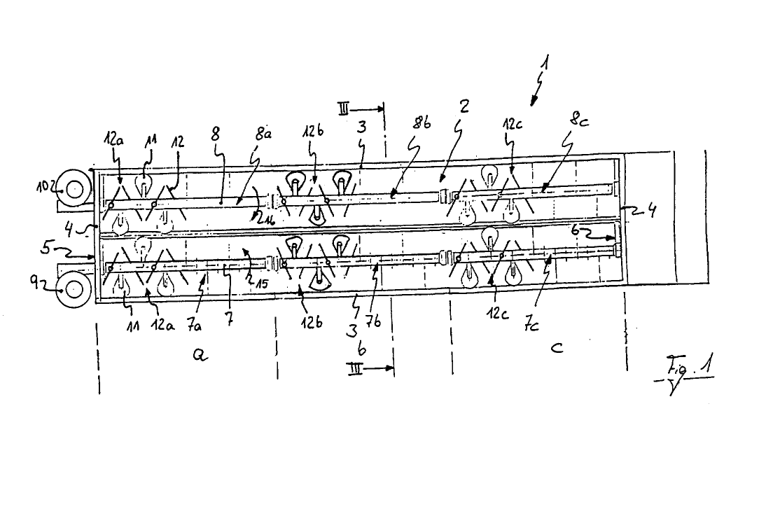

The device 1 according to FIG. 1 comprises at least one mixing chamber 2 free of inner transverse walls (partitions) and delimited only by outer walls 3, 4 and one intermediate wall 32 relative to an additional mixing chamber 2.

For filling the material to be mixed into the device, the mixing chamber 2 or each mixing chamber has at one end an inlet opening 5 which can be formed, for example, as an insertion channel opening from above into mixing chamber 2. An outlet opening 6 for removing the material to be mixed is provided spaced from the inlet channel; in the illustrated embodiment, the outlet opening is located at the opposite end.

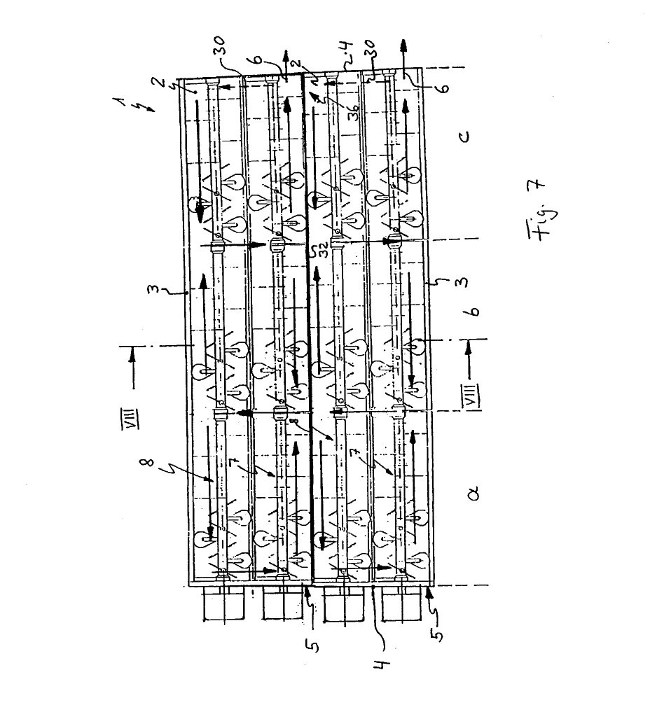

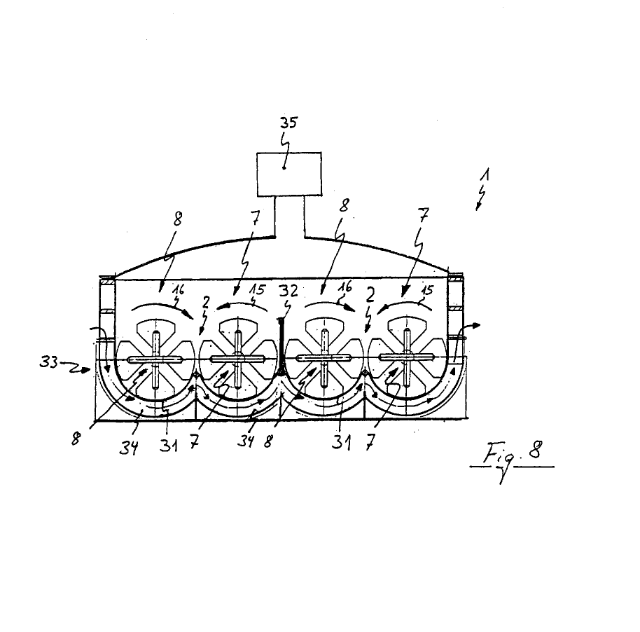

The device 1 comprises two parallel adjacently positioned shafts 7, 8 arranged in the mixing chamber 2. The shafts 7, 8 can be rotated by drives 9, 10. The parallel arrangement illustrated in FIGS. 7 and 8 shows two mixing chambers arranged adjacent to one another and separated from one another by an intermediate wall 32; two shaft pairs 7, 8 are provided in each mixing chamber and are positioned parallel to the intermediate wall 32.

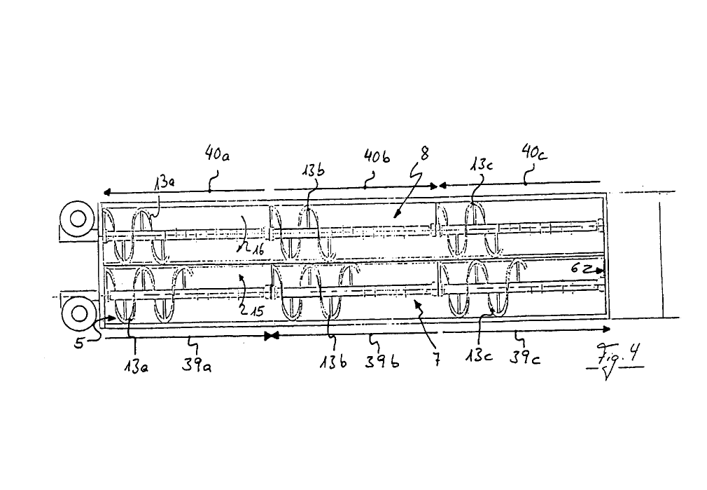

The shafts 7, 8 have shaft bodies serving as supports for mixing members 11 and conveying members 12 (only schematically indicated in FIGS. 1 and 7). In a second embodiment (FIG. 4), the mixing and conveying members are combined in the form of a spiral conveyor 13 which is also only schematically shown in the drawing.

In both embodiments, the shafts 7 and 8 have the same direction of revolution across the entire extension of the mixing chamber 2; this is however not mandatory. Alternatively, an intermediate gearbox can be provided across the extension of each shaft 7, 8. However, a continuous direction of revolution can be realized more simply.

Also, the intermediate supports of the shafts 7, 8 within the mixing chamber 2 can be omitted.

The shafts 7 and 8 rotate with opposite rotational directions 15, 16. Each of the shafts 7, 8 has on its path between the area of the inlet opening 5 and the outlet opening 6 different sections 7a, 7b, 7c or 8a, 8b, 8c. The sections 7a and 7c convey in the direction of the outlet opening 6; the section 7b conveys in the direction of inlet opening 5. On the other hand, the sections 8a and 8c of the shaft 8 convey in the direction of the inlet opening 5 and the section 8b in the direction of the outlet opening 6. This is illustrated by the arrows 39a, 39b, 39c and 40a, 40b, 40c indicating the conveying direction.

In order to ensure the different conveying directions along the different sections of each shaft 7, 8, respectively, the conveying members 12 or 13 are arranged in different orientation relative to the shafts 7 or 8. In the first section 7a, the conveying members 12a or 13a are arranged such that in the case of the shaft 7 rotating in the rotational direction 15, conveying of the material to be mixed is effected in the direction of the arrow 39a. The same holds true for the arrangement of the conveying members 12c, 13c on the shaft 7 so that in the last section conveying by the shaft 7 is effected in the direction of arrow 39c and thus in the direction of outlet opening 6. The central conveying members 12b, 13b are arranged so as to convey in the opposite direction so that in this section a conveying direction 39b oriented in the direction toward the inlet opening 5 results.

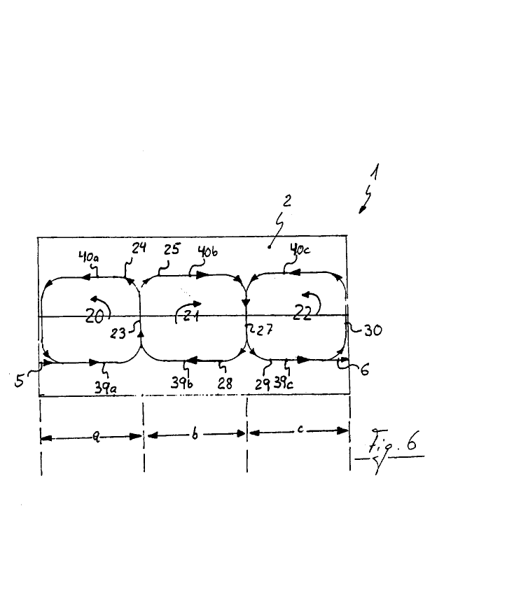

For the opposite direction of rotation 16 of the parallel supported shafts 8 and for the same orientation of the arrangement of the conveying members 12a, 13a; 12b, 13b; and 12c, 13c, opposite conveying directions 40a, 40b and 40c result in the individual sections, respectively. The conveying members 12, 13 can be configured to be identical; it may be provided that in the end area, viewed in the conveying direction 39a, 39b, 39c or 40a, 40b, 40c of each section a, b, c, several conveying members 12, 13 are provided with a special transverse conveyer so that a material circulation path 20, 21, 22 (FIG. 6) can be ensured within sections a, b, c, wherein the circulation paths 20, 21, 22 are generated by oppositely conveying sections 7a, 8a; 7b, 8b; or 7c, 8c of the shafts 7, 8 and include in the transition area a transverse component between the shafts 7, 8. Instead of the three illustrated sections a, b, c with the three circulation paths, a different number of sections and correlated paths is also possible, depending on the mixing chamber length and the type of the components to be mixed.

The material flow is divided in the area of the transverse conveying action 23 into a portion 24 remaining within the circulation path 20 and a portion 25 passing into that the next section b, wherein the portion 24 is conveyed in the direction of arrow 40a and remains in the section a while the portion 25 is conveyed in the direction of the arrow 40b and reaches as a component of the circulation path 21the section b. At the end of the section b, this portion 25 impacts on the oppositely rotating conveying section c of the shaft 8 so that it is not conveyed farther in the direction of the outlet opening 6 but experiences a transverse conveying action 27 and is divided again into the components 28 and 29. The component 28 remains in the section b and is entrained by the first shaft 7 in the return direction 39b, while the portion 29 enters the third circulation path 22 and is entrained by the shaft 7 rotating in the direction 39c. At the end of the circulation path 22 the flow is divided again; a part of the conveyed material to be mixed is conveyed through the outlet opening 6 of the mixing chamber 2, a further portion reaches by a last transverse conveying action 30 the oppositely positioned shaft 8 and is conveyed into direction of arrow 40c again in the opposite direction and subjected to the transverse conveying action 27.

In this way, in each circulation paths 20, 21, 22 a part of the material to be mixed is subjected to further conveying into the next circulation path 21, 22 or to the outlet opening 6, while another portion remains within the respective circulation path 20, 21, 22 and is subjected to a further mixing action. Because of the division of the returning transverse components 23, 27, a portion of the material to be mixed can be returned into an upstream circulation path 20, 21.

In this way, a very intensive mixing action is possible, even for materials which contain an adhesive or liquid phase.

During the operation of the device, material to be mixed is continuously supplied to the outlet opening 6 so that material to be mixed can be continuously supplied through the inlet opening 5. The device 1can therefore be operated in continuous operation. Such a continuous operation was possible in the past only in mixers with several chambers which are separated from one another by partitions and exhibit the above-mentioned disadvantages.

The guide surfaces for the material to be mixed are substantially in the form of semi-tubular boundary walls 31which delimit the circulation space for the mixing and conveying members 11, 12 of the shafts 7, 8. As a result of the tight contact of the mixing and conveying members 11, 12 on these walls 31it is ensured that material to be mixed does not remain unaffected or unmixed in the bottom area.

The device 1 can be arranged on a frame or support and can be pivotable relative to it in a variable or fixed way such that the material to be mixed must move against an incline on its path from the inlet opening 5 to the outlet opening 6 or can move on a downward slant aided by gravity. This can be expedient particularly for mixing components of which at least one is a liquid. Also, for cleaning purposes, a slant of the mixing chamber 2 can be expedient.

The device 1 can have correlated therewith a heating device 33 which comprises heating channels 34. The heating channels 34 are arranged underneath the limiting walls 31 limiting the mixing chamber in the downward direction and cover substantially the entire surface area in order to provide a large contact surface area. Since the heating channels 34 extend up to the lateral area, an excellent heat transfer from the channels 34 into the limitation walls 31 and into the material contained in the mixing chamber is ensured. The heated surface area is greater than that resulting from a planar surface.

The heating medium can be, for example, water, steam, or different thermal oils. The heating temperature is typically within approximately 180 degrees Celsius to 200 degrees Celsius. However, this can vary.

Drying is required, for example, in the case of food stuff from which water is to be removed. Also, in the case of sewage sludge or the like drying can be necessary. Depending on the residence time of the material in the mixing chamber 2, the contents of the solid matter can be increased significantly. For example, the so-called solid matter contents after a residence time of 10 minutes can be increased from 60 percent up to 90 percent and after a residence time of half an hour from 90 percent to 98 percent.

In addition to or as an alternative, a pump device 35 can be provided in order to load the mixing chamber 2 with vacuum (under pressure). The boiling temperature of water contained in the material to be mixed can thus be reduced. Pressures down to a fine vacuum are conventional. For this purpose, for example, vane pumps or rotary piston pumps, such as water ring pumps, can be used. For improving stability, the cover 35 which closes off the mixing chamber 2 pressure-tightly in the upward direction can be configured in a dome shape.

In order to be able to perform a drying process continuously, a lock or sluice for filling in and removing material to be mixed can be provided, for example, in the form of a cellular wheel sluice or a star feeder.

The configuration of several mixing chambers 2 in parallel or serial connection can be more beneficial with respect to energy considerations than a large mixing chamber. It may also be provided to have a material transfer between the adjacently positioned mixing chambers in the area 36 (FIG. 7) so that the material to be mixed passes completely the circulation paths of the different mixing chambers 2 and the material to be mixed is not only mixed within one chamber 2. For example, in the area 36 a transverse conveying screw or a similar transverse conveying device can be provided. This device would then effect parallel to the indicated arrows 30 a material transfer between the adjacently positioned mixing chambers 2.

Since each mixing chamber 2 is free of partitions, by means of a control of the degree of opening of the outlet opening 6 a counter pressure can be adjusted with which the advance of the material to be mixed in the mixing chamber 2 can be affected. A continuous operation is then particularly beneficial. By means of the counter pressure it can be determined for which period of time the material to be mixed remains within the first section a, when it is transferred into the second section b and the third section c or any additional section. In this way, it is possible to effect in a very sensitive way the mixing behavior simply by controlling a valve. For example, when the outlet valve 6 is closed, the residence time of the material to be mixed can be adjusted such that it passes through the first circulation path 20 twice and only thereafter is transferred into the second circulation path 21. When the outlet valve 6 is open, a transfer would be possible during the first circulation within the circulation path 20.

Inasmuch as several mixing chambers 2 are arranged adjacent to one another and parallel in a device 1, the shaft diameter of the shafts 7, 8 can also be reduced for improving spatial utilization, for example, from a standard size of 225 mm to a size of 100 mm.

The device 1thus exhibits an adjustable mixing behavior in continuous operation with simultaneous drying option, wherein the mixing behavior can be adjusted in a targeted way and can be finely metered by means of a outlet valve 6.

The device according to the invention thus makes it possible to mix continuously material to be mixed comprised of very different compositions.

Also, granulation of alumina is possible. Alumina forms solid chunks which cannot be used as such. The chunks must be comminuted and granulated in a mixing device. This can be achieved by adding approximately 3 to 5 percent of lime during mixing. In this way, a digestion of alumina results which prevents lumping. In this way, disposal in a landfill is no longer required. The formed granular material can be used further. The same is possible also with mud or the like.

In the case of other materials, such as aluminum sulfate, cooling is required. The sulfate is supplied by tank cars at a temperature of approximately 55 degrees Celsius. Lumping can then be achieved only by cooling for which purpose water is supplied to the mixer. The evaporation heat than results in cooling. By loading the material to be mixed with under pressure (vacuum), the evaporation is enhanced.

In all versions, the material to be mixed is forced by the mixing and conveying elements into the respective circulation paths. In this way, the amount of material to be mixed is significantly increased relative to pressing of the material counter to the conveying direction of the conveying members. Only in this way, a continuous and fast mixing action can be achieved.

While specific embodiments of the invention have been shown and described in detail to illustrate the inventive principles, it will be understood that the invention may be embodied otherwise without departing from such principles.

What is claimed is:

1. A device for mixing a material to be mixed comprised of at least two components, the device comprising:
outer walls defining a mixing chamber;
the mixing chamber having an inlet opening for introducing a material to be mixed into the mixing chamber and an outlet opening spaced from the inlet opening for removing the material to be mixed after mixing from the mixing chamber;
at least two mixing and conveying tools arranged in the mixing chamber and acting on the material to be mixed between the inlet opening and the outlet opening;
wherein the mixing and conveying tools are formed such that the material to be mixed is conveyed in the mixing chamber by each one of the mixing and conveying tools with at least one first section of the tools, respectively, in a first direction toward the outlet opening and with at least one second section of the tool, respectively, in a second direction opposite to the first direction.

2. The device according to claim 1, wherein the at least one first section and the at least one second section are arranged on an imaginary line between the inlet opening and the outlet opening in alternating sequence defining a first conveying path.

3. The device according to claim 2, wherein between the at least one first section and the at least one second section a boundary area is provided and configured to conveying the material to be mixed transversely to the imaginary line, respectively.

4. The device according to claim 2, wherein parallel to the imaginary line a second conveying path is provided for the material to be mixed, wherein the second conveying path moves the material to be mixed in a conveying direction counter to the conveying direction of the first conveying path.

5. The device according to claim 2, wherein the mixing and conveying tools comprise a shaft body, respectively, extending substantially in the direction of the imaginary line or parallel to the imaginary line, and further comprise mixing members and conveying members arranged on the shaft bodies.

6. The device according to claim 5, wherein the shaft bodies are horizontal shafts and wherein the conveying members comprise first conveying members conveying the material to be mixed in the first direction and second conveying members conveying the material to be mixed in the second direction, wherein the first and second conveying members are arranged alternatingly on the horizontal shafts in the first and second sections, respectively.

7. The device according to claim 6, wherein the shaft bodies are arranged such that the first sections of a first one of the shaft bodies are positioned adjacent to and aligned with the second sections of a second one of the shaft bodies.

8. The device according to claim 1, comprising two semi-tubular limiting walls delimiting a bottom of the mixing chamber, wherein the semi-tubular limiting walls are guide surfaces for the material to be mixed.

9. The device according to claim 8, comprising a heating device for heating the mixing chamber.

10. The device according to claim 9, wherein the heating device has heating channels formed to match the shape of bottom of the mixing chamber.

11. The device according to claim 1, comprising a pumping device configured to supply the mixing chamber with a vacuum.

12. A method for mixing a material to be mixed comprised of at least two components in a mixing chamber having an inlet area and an outlet area spaced from the inlet area, the method comprising the steps of:
a)introducing the material to be mixed via an inlet opening into the mixing chamber;
b)conveying the material to be mixed by a first section of a mixing and conveying tool provided with a first set of mixing and conveying members in a first conveying direction toward the outlet opening;
c) at the end of the first section guiding the material to be mixed onto a second section of the mixing and conveying tool having a second conveying direction opposite to the first conveying direction of the first section and subjecting the material to be mixed to a transverse conveying action.

13. The method according to claim 12, further comprising the step of subjecting a first portion of the material to be mixed after the step c) to an action of a second set of mixing and conveying members arranged antiparallel to the first set of mixing and conveying members and conveying the first portion of the material to be mixed away from the outlet opening.

14. The method according to claim 13, wherein an end area of the second set of mixing and conveying tools imparts a transverse conveying action to the first portion of the material to be mixed and feeds the material to be mixed on a first circulation path to the first set of mixing and conveying members in the area of the inlet opening.

15. The method according to claim 13, wherein a second portion of the material to be mixed after the step c) is subjected to an action of a third set of mixing and conveying members, oriented parallel to the first set but arranged transversely thereto and, relative to a line between the inlet opening and the outlet opening, staggered relative to the first set, and is conveyed in the first conveying direction toward the outlet opening.

16. The method according to claim 15, wherein the second portion of the material to be mixed is supplied transversely on a second circulation path oriented opposite to the first circulation path at least partially to a fourth set of mixing and conveying members and conveyed in the second conveying direction toward the inlet opening.

17. The method according to claim 12, further comprising the step of guiding the material to be mixed in several alternatingly circulating circulation paths between the inlet opening and the outlet opening.

18. The method according to claim 12, comprising the steps of continuously supplying the material to be mixed via the inlet opening into the mixing chamber and continuously removing the material to be mixed after mixing from the outlet opening.
